(19) United States
(12) Patent Application Publication
(10) Pub. No.: US 2013/0182122 A1
(43) Pub. Date: Jul. 18, 2013

(54) INFORMATION PROCESSING APPARATUS AND METHOD

(71) Applicant: Toshiba Tec Kabushiki Kaisha, Tokyo (JP)

(72) Inventors: Hidehiro Naito, Shizuoka-ken (JP); Hitoshi Iizaka, Shizuoka-ken (JP); Hidemi Mihara, Shizuoka-ken (JP)

(73) Assignee: TOSHIBA TEC KABUSHIKI KAISHA, Tokyo (JP)

(21) Appl. No.: 13/736,129

(22) Filed: Jan. 8, 2013

(30) Foreign Application Priority Data
Jan. 13, 2012 (JP) 2012-005302

(51) Int. Cl. H04N 5/232

(52) U.S. Cl. CPC H04N 5/23296
USPC 348/169

(57) ABSTRACT

According to one embodiment, an information processing apparatus includes an acquirement unit configured to acquire a color image captured by an image capturing unit, an image conversion unit configured to convert the acquired color image into a monochrome image, a first recognition unit configured to specify an commodity included in the image captured by the image capturing unit based on the monochrome image, a second recognition unit configured to specify the commodity included in the image captured by the image capturing unit based on the acquired color image if the commodity cannot be specified by the first recognition unit and an output unit configured to output information showing the commodity specified by the first recognition unit or the second recognition unit.

### CROSS-REFERENCE TO RELATED APPLICATION

This application is based upon and claims the benefit of priority from Japanese Patent Application No. 2012-005302, filed Jan. 13, 2012, the entire contents of which are incorporated herein by reference.

### FIELD

Embodiments described herein relate to an information processing apparatus and a method.

### BACKGROUND

The following technology that a commodity to be subjected to sales registration is specified by carrying out the recognition of the commodity such as fruit, vegetable and the like by utilizing a technology relevant with generic object recognition existed. About the generic object recognition, by reading code information such as bar code or QR code (registered trademark) and the like attached to the commodity or extracting the characteristic quantity of an commodity from the image data of the captured commodity, the characteristic quantity is compared with previously prepared contrast data (characteristic quantity), so as to recognize (detect) the category and the like of the commodity.

### BRIEF DESCRIPTION OF THE DRAWINGS

FIG. 1 is a perspective view showing an example of a checkout system (store system) according to the embodiment;

FIG. 2 is a sketchy longitudinal sectional side view of a commodity reading apparatus;

FIG. 3 is a block diagram showing hardware components of a POS terminal and the commodity reading apparatus;

FIG. 4 is a conceptual diagram illustrating an example of a data of a PLU file;

FIG. 5 is a block diagram showing functional components of the POS terminal and the commodity reading apparatus;

FIG. 6 is a flow chart showing an example of the action operations of the commodity reading apparatus; and

FIG. 7 is a flow chart showing an example of the action operations of the POS terminal.

### DETAILED DESCRIPTION

In accordance with one embodiment, an information processing apparatus includes an acquirement unit configured to acquire a color image captured by an image capturing unit, an image conversion unit configured to convert the acquired color image into a monochrome image, a first recognition unit configured to specify an commodity included in the image captured by the image capturing unit based on the monochrome image, a second recognition unit configured to specify the commodity included in the image captured by the image capturing unit based on the acquired color image if the commodity cannot be specified by the first recognition unit and an output unit configured to output information showing the commodity specified by the first recognition unit or the second recognition unit.

The embodiment of the information processing apparatus and the program is described in detail with reference to drawings. The embodiment described below is one embodiment of the information processing apparatus and the program, but is not limited the compositions, and the specifications. The present embodiment is an example of application applied to a checkout system (store system) introduced into a store such as a supermarket and the like and comprising a POS terminal carrying out the registration and the account settlement of a commodity (article) in one transaction relates.

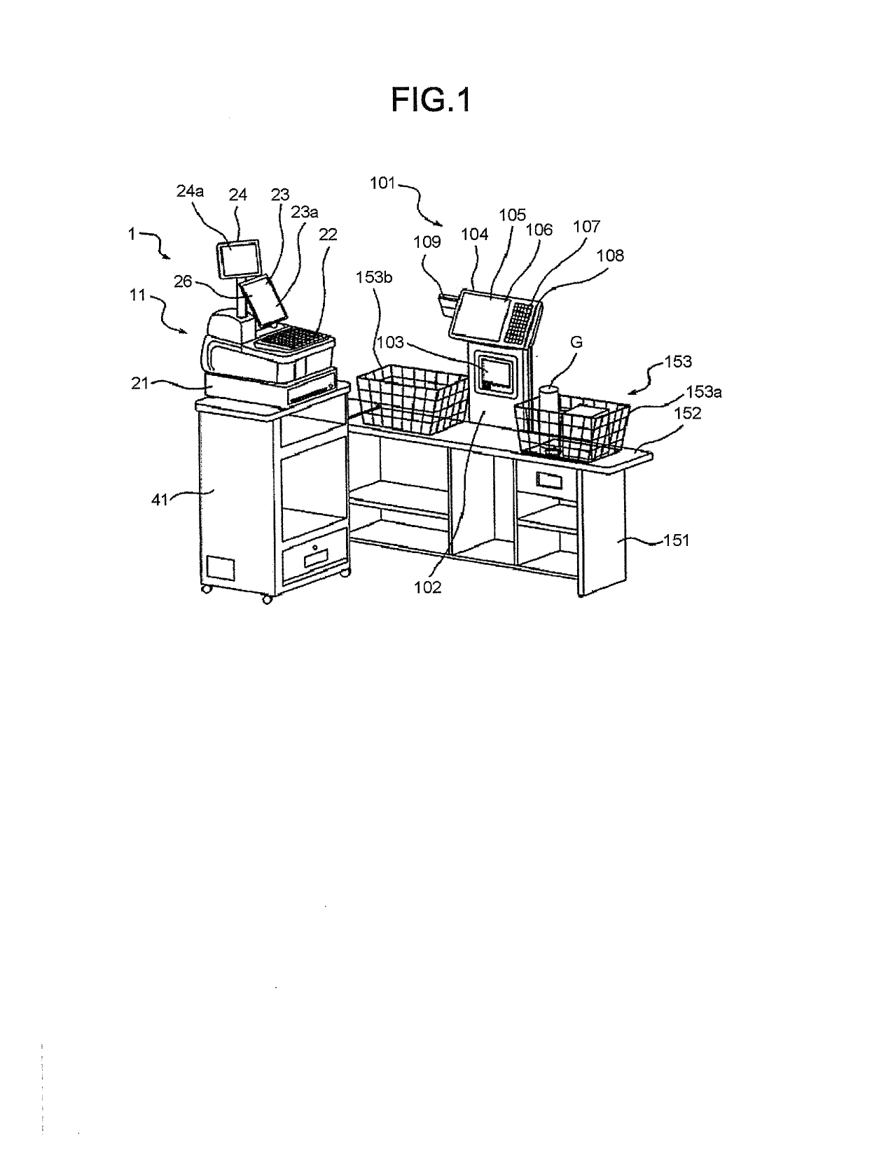

FIG. 1 is a perspective diagram showing an example of the checkout system 1. As shown in FIG. 1, the checkout system 1 comprises: a commodity reading apparatus 101 reading information relevant with the commodity, and the POS terminal 11 carrying out the registration and the account settlement of the commodity in one transaction relates. The example that the commodity reading apparatus 101 is applied as the information processing apparatus in the present embodiment relates is described. Besides, same compositions shown in a plurality of drawings are marked with same symbols to carry out graphical representation, and their repeated descriptions are omitted sometimes.

The POS terminal 11 is placed on the upper surface of a cash drawer 21 on a checkout counter 41. The open operation of the cash drawer 21 is controlled by the POS terminal 11. A keyboard 22 pressed down by an operator (salesclerk) is configured on the upper surface of the POS terminal 11. A display 23 displays the information towards the operator is arranged at a position more backside than the keyboard 22 form the operator who operates the keyboard 22. The display 23 displays the information on a display surface 23a. A touch panel 26 is laminated on the display surface 23a. A display for customer 24 is arranged at a position approaching the inner side more than the display 23 in a rotatable way. The display for customer 24 displays the information on a display surface 24a. The display for customer 24 shown in FIG. 1, the display surface 24a is enabled to face to a front side in FIG. 1, but the display for customer 24 displays the information towards a customer by rotating the display for customer 24 in the way of enabling the display surface 24a to face to the inner side in FIG. 1.

A table-shaped counter 151 having a wide-width is arranged to form L shape with the checkout counter 41 equipped with the POS terminal 11. A placing surface 152 is formed on the upper surface of the counter 151. A shopping basket 153 in which a commodity G is accommodated is placed on the placing surface 152. The shopping basket 153 can be distinguished in use to a first shopping basket 153a that a customer takes onto the counter 151 and a second shopping basket 153b placed at a position opposite to the first shopping basket 153a via the commodity reading apparatus 101. The shopping basket 153 is not limited to an object in an ordinary basket, a tray and the like. The shopping basket 153 (the second shopping basket 153b) is not limited to an ordinary basket shape and box-shaped or bag-shaped and the like.

The commodity reading apparatus 101, which is connected with the POS terminal 11 to transmit and receive data with the POS terminal 11, is arranged on the placing surface 152 of the counter 151. The commodity reading apparatus 101 comprises a rectangular housing 102 having a relatively thin length. A reading window 103 is arranged at the front side of the housing 102. A display and operation unit 104 is mounted on the upper portion of the housing 102. A display 106 having a touch panel 105 laminated on the surface thereof is arranged on the display and operation unit 104. A keyboard 107 is arranged at the right side of the display 106. A card reading slot 108 of a card reader which is not shown in figures is arranged at the right side of the keyboard 107. A display 109 used for providing the information for the customer is arranged at the left inner side of and behind the display and operation unit 104 at a position at which the operator operates the display and operation unit 104.

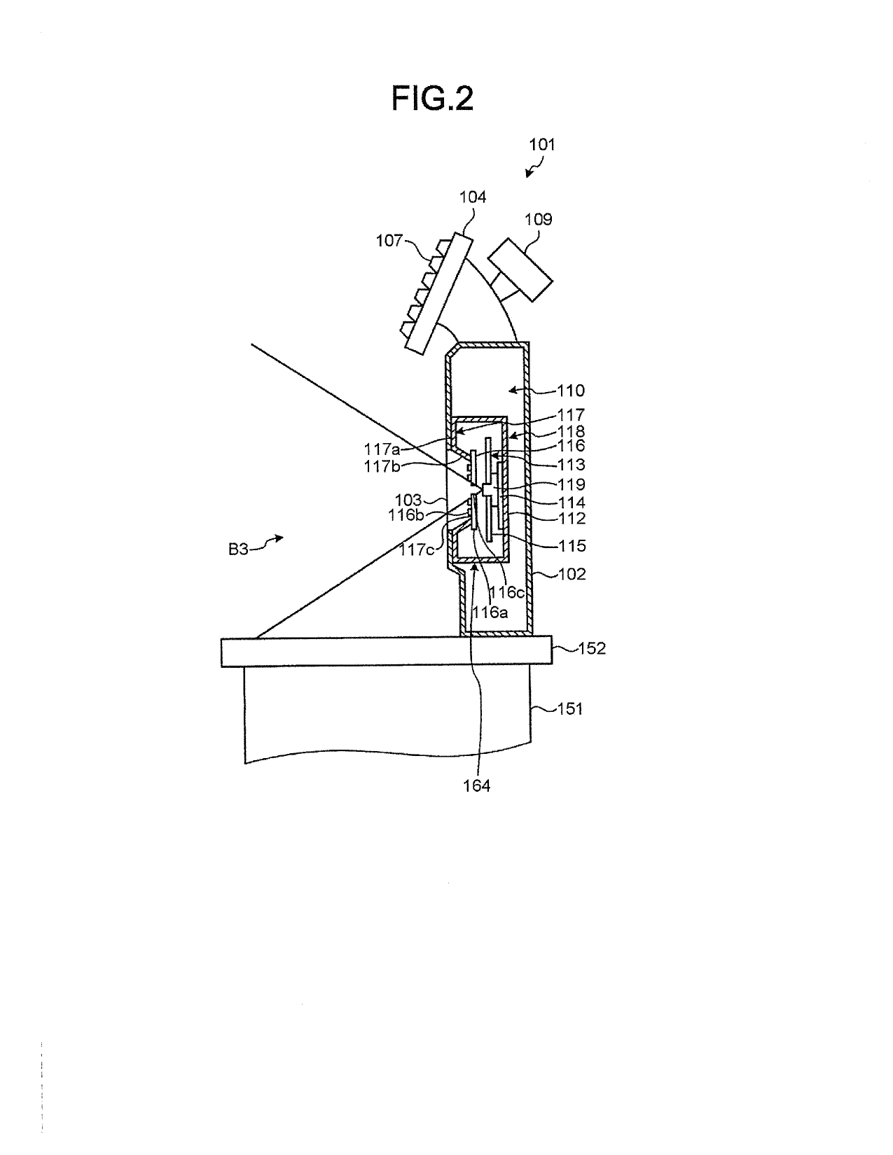

Such a commodity reading apparatus 101 comprises a commodity reading unit 110 (refer to FIG. 2). The commodity reading unit 110 is equipped with a image capturing unit 164 (refer to FIG. 2) at the inner side of the reading window 103.

The commodity Gin one transaction relates is contained in the first shopping basket 153a held by the customer. The commodity G in the first shopping basket 153a is moved to the second shopping basket 153b by the operator operating the commodity reading apparatus 101. In the movement process, the commodity G is enabled to face to the reading window 103 of the commodity reading apparatus 101. At the moment, the image capturing unit 164 (refer to FIG. 2) configured in the reading window 103 captures the commodity G.

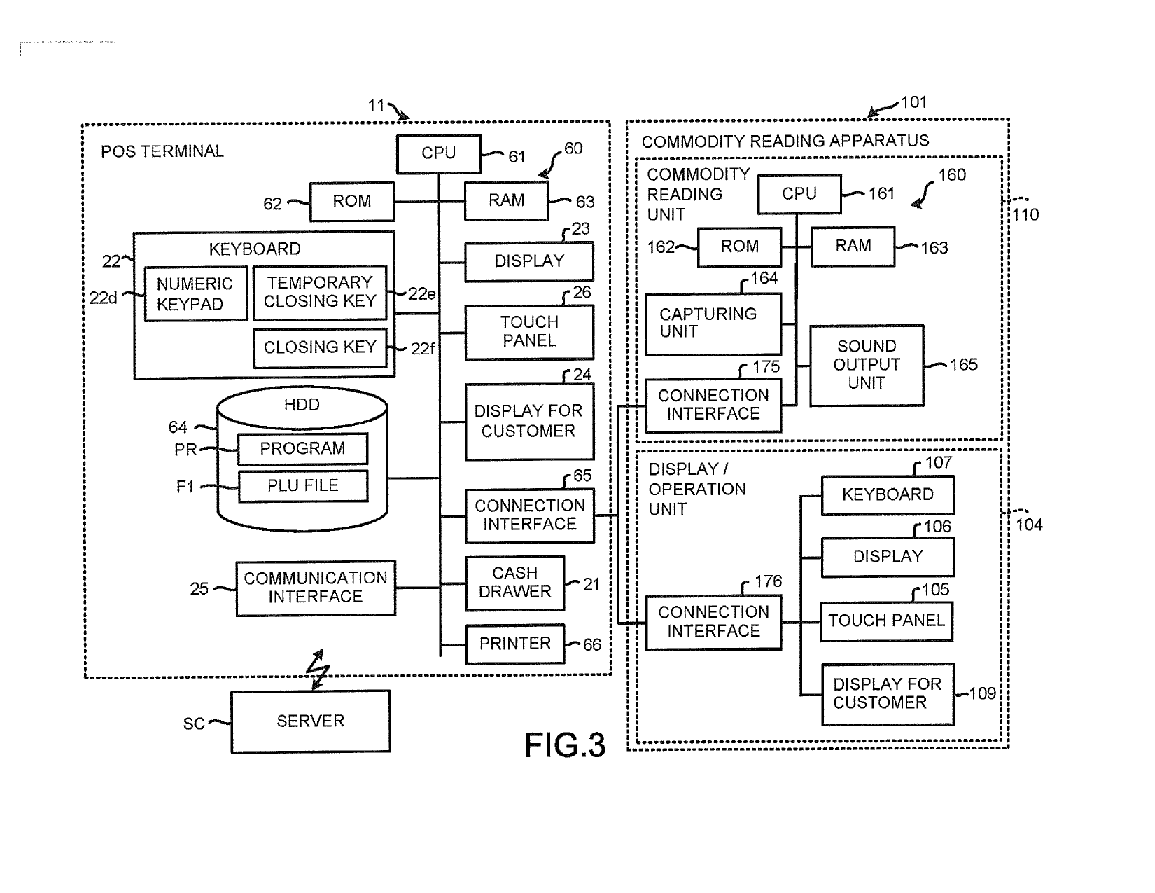

In the commodity reading apparatus 101, with reference to a PLU file F1 (refer to FIG. 3), the commodity G included in the image captured by the image capturing unit 164 is specified by the reading of code information such as a bar code or a QR code (registered trademark) and the like attached to the commodity G or generic object recognition (described in detail below). In the commodity reading apparatus 101, a picture receiving the input of the confirmation, the number and the like of the specified commodity G is displayed on the display and operation unit 104, and information confirming and inputting the received commodity ID of the commodity G, the input number and the like is notified to the POS terminal 11. In the POS terminal 11, the information relating to sales registration, such as the commodity category, the commodity name, the unit price and the like of the commodity corresponding to the commodity ID is recorded in a sales master file (not shown in the figures) and the like based on the information such as the commodity ID, the number and the like notified from the commodity reading apparatus 101, so as to carry out the sales registration.

FIG. 2 is a sketchy longitudinal sectional side view of the commodity reading apparatus 101. In the commodity reading apparatus 101, the built-in commodity reading unit 110 is arranged in the housing 102. The commodity reading unit 110 comprises the image capturing unit 164 acquiring the commodity G existing in an image capturing region B3 or used for reading the image of the commodity ID according to a code symbol attached to the commodity G.

The image capturing unit 164 comprises a box-shaped frame 112 which is formed by a surface side cover component 117 configured on one side of the image capturing region B3 where the commodity G is positioned and an inner side cover component 118 arranged at the opposite side of the surface side cover component 117 and configured with the surface side cover component 117 in a combinative way.

The frame 112 internally comprises: an image capturing board 113 with a CCD image sensor capturing the color image, an illumination board 116 which is an illumination apparatus irradiating illumination light in the image capturing region B3, and an image processing board 115 carrying out image processing on the captured image (color image) acquired by the CCD (Charged Coupled Device) image sensor (or the CMOS (Complementary Metal Oxide Semiconductor) image sensor).

Besides that the surface side cover component 117 is equipped with a surface board 117a, a concave 117b is inwards formed on the central part of the surface board 117a. The concave unit 117b is formed into a tetragonal-hammer-shaped wall surface; the more the wall surface approaches the inner side, the more the area of cross section of the wall surface is decreased; an open unit 117c is arranged at the innermost part of the concave unit 117b.

The capturing board 113 comprises: a capturing basal board 114 with a CCD image sensor (or a CMOS image sensor) and a drive circuit of the CCD image sensor, and an imaging lens 119 imaging the captured image of the image capturing region B3 on the CCD image sensor, and the CCD image sensor (or the CMOS image sensor) is a color sensor. The image processing board 115 is an image processing apparatus and outputs dynamic image data (frame data) output from the capturing board 113.

The illumination board 116 is configured at the inner side of the open unit 117c. A capturing open unit 116c of the capturing board 113 is arranged in a basal board 116a of the illumination board 116. A plurality of LED light-emitting elements 116b are configured on the basal board 116a of the illumination board 116 in the way of enclosing the open unit 116c, and the basal board 116a of the illumination board 116 is positioned in the open unit 117c at the innermost part of the concave unit 117b. Therefore, the plurality of LED light-emitting elements 116b irradiates the light towards an illumination region wider than the image capturing region B3.

The image capturing unit 164 formed in such a way enables the position of the open unit 117c and the reading window 103 formed in the housing 102 of the commodity reading apparatus 101 to be subjected to position matching and is internally arranged in the housing 102. Therefore, the capturing board 113 is enabled to face to the image capturing region B3 positioned outside the reading window 103. The imaging lens 119 has such a focal distance enabling the focal point of reflected light from the image capturing region B3 to be gathered at the CCD image sensor. Therefore, the capturing basal board 114 arranged on the capturing board 113 and the imaging lens 119 acquire the color image of the commodity G positioned in the image capturing region B3.

FIG. 3 is a block diagram showing hardware components of the POS terminal 11 and the commodity reading apparatus 101. The POS terminal 11 comprises a microcomputer 60 which functions as an information processing unit executing an information processing. The microcomputer 60 includes a CPU (Central Processing Unit) 61 for executing various operations to control each other unit, a ROM (Read Only Memory) 62 and a RAM (Random Access Memory) 63 which are respectively connected to the CPU 61 via a bus line.

The above-mentioned cash drawer 21, the keyboard 22, the display 23, the touch panel 26 and the display for customer 24 are all connected with the CPU 61 of the POS terminal 11 through various input and output circuits (all not shown in the figures). These devices or units are controlled by the CPU 61.

The keyboard 22 comprises numeric keypads 22d on the surface of which numerals “1”, “2”, “3”. . . and operators such as “x” are displayed, a temporary closing key 22e and a closing key 22f.

The CPU 61 of the POS terminal 11 is connected with an HDD (Hard Disk Drive) 64. The programs and various files are stored in the HDD 64. If the POS terminal 11 is activated, the programs and files stored in the HDD 64 are wholly or partially copied to the RAM 63 to be sequentially executed by the CPU 61. An example of the program stored in the HDD 64 is a program PR for processing commodity sales data. An example of the files stored in the HDD 64 is the PLU file F1 which is transmitted from a store computer SC to the POS terminal and then stored in the HDD 64.

The PLU file F1 is a file in which the sales registration information of each of the commodity G exhibited and sold in a shop is associated with the image of the commodity G.

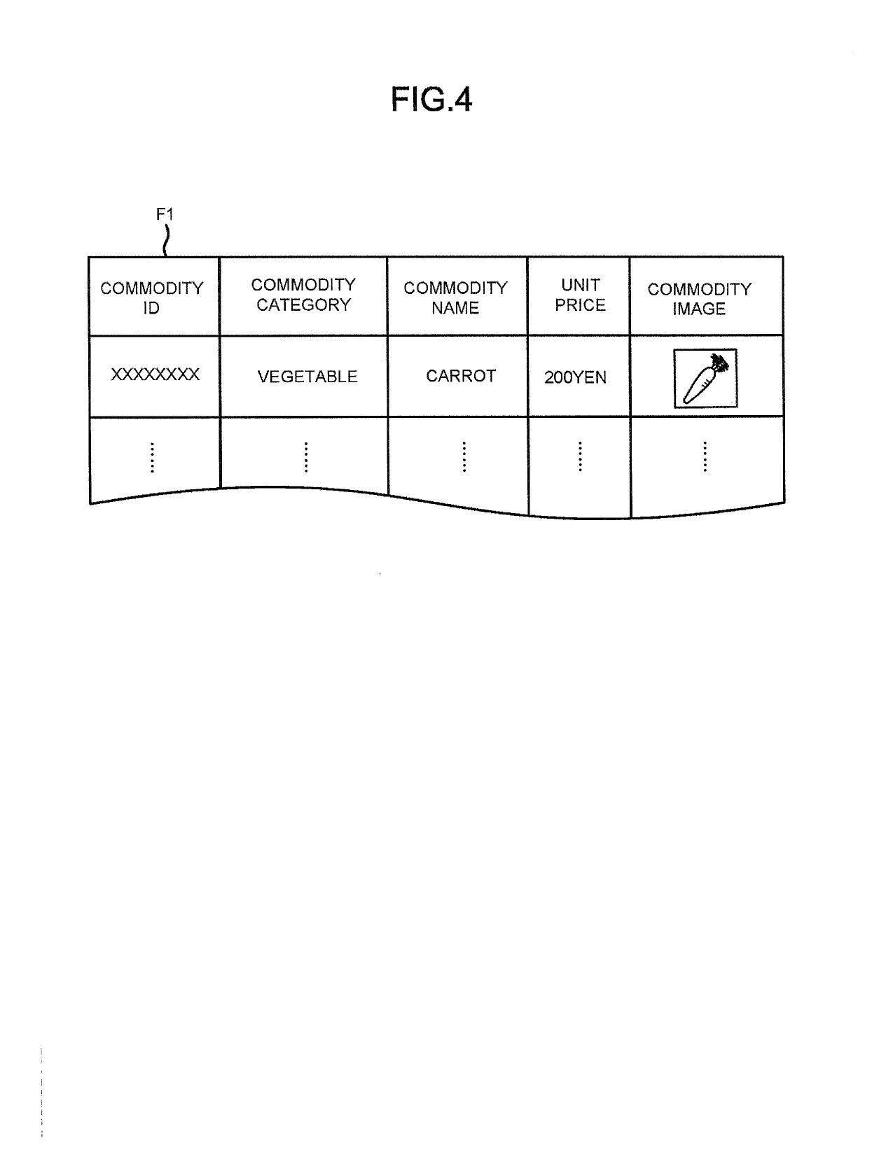

FIG. 4 is a conceptual graph exemplifying data compositions of the PLU file F1. As shown in FIG. 4, the PLU file F1 is a file in which the sales registration information including the commodity ID uniquely assigned, the commodity category, the commodity name, the unit price and the like, and a commodity image (reference image) capturing the commodity as the commodity information of the commodity G for each commodity G are stored. The commodity image is the captured image (a photo) of the commodity used for similarity determine. The PLU file F1 is formed to be capable of being read out by the commodity reading apparatus 101 through the following connection interface 65.

The data composition of the PLU file F1 is not limited to the example in FIG. 4, for instance, the data composition is set to be the form that a characteristic quantity such as a hue or a surface concave-convex status and the like read from the commodity image is stored for each commodity. The PLU file F1 storing the commodity information also can be stored in an external apparatus such as a server apparatus and the like except the POS terminal 11.

Referring back to FIG. 3, a communication interface 25 used for executing data communication with the store computer SC is connected with the CPU 61 of the POS terminal 11 via an input and output circuit (not shown in the figures). The store computer SC is installed in the backyard of the store. The PLU file F1 to be sent to the POS terminal 11 is stored in the HDD (not shown in the figures) of the store computer SC.

The CPU 61 of the POS terminal 11 is connected with the connection interface 65 which enables a data transmission and reception between the CPU and the commodity reading apparatus 101. The connection interface 65 is connected with the commodity reading apparatus 101. the CPU 61 of the POS terminal 11 is connected with a printer 66 printing a receipts and the like. The POS terminal 11 prints the transaction content of one transaction on the receipt under the control of the CPU 61.

The commodity reading apparatus 101 further comprises a microcomputer 160. The microcomputer 160 includes a ROM 162 and a RAM 163 connected with a CPU 161 via a bus line. The programs executed by the CPU 161 are stored in the ROM 162. The image capturing unit 164 and a sound output unit 165 are connected with the CPU 161 through various input and output circuits (all not shown in the figures) . The operations of the image capturing unit 164 and the sound output unit 165 are controlled by the CPU 161. The display and operation unit 104 is connected with the commodity reading unit 110 and the POS terminal 11 through a connection interface 176. The operations of the display and operation unit 104 are controlled by the CPU 161 of the commodity reading unit 110 and the CPU 61 of the POS terminal 11.

The image capturing unit (scanner) 164 is a color image sensor of the CCD image sensor or the CMOS image sensor and the like, is the capturing unit carrying out capturing with a color from the reading window 103 under the control of the CPU 161. For instance, the capturing of a 30 fps dynamic image is carried out in the image capturing unit 164. Frame images (captured images) captured in sequence by the image capturing unit 164 with a specified frame per second are stored in the RAM 163.

The sound output unit 165 consists of a sound circuit, a loudspeaker and the like used for radiating a preset warning sound. The sound output unit 165 informs events with warning sound under the control of the CPU 161.

Further, the CPU 161 is connected with a connection interface 175 which is connected with the connection interface 65 of the POS terminal 11 transmit and receive the data with the POS terminal 11. The CPU 161 receives and transmits the data with the display and operation unit 104 through the connection interface 175.

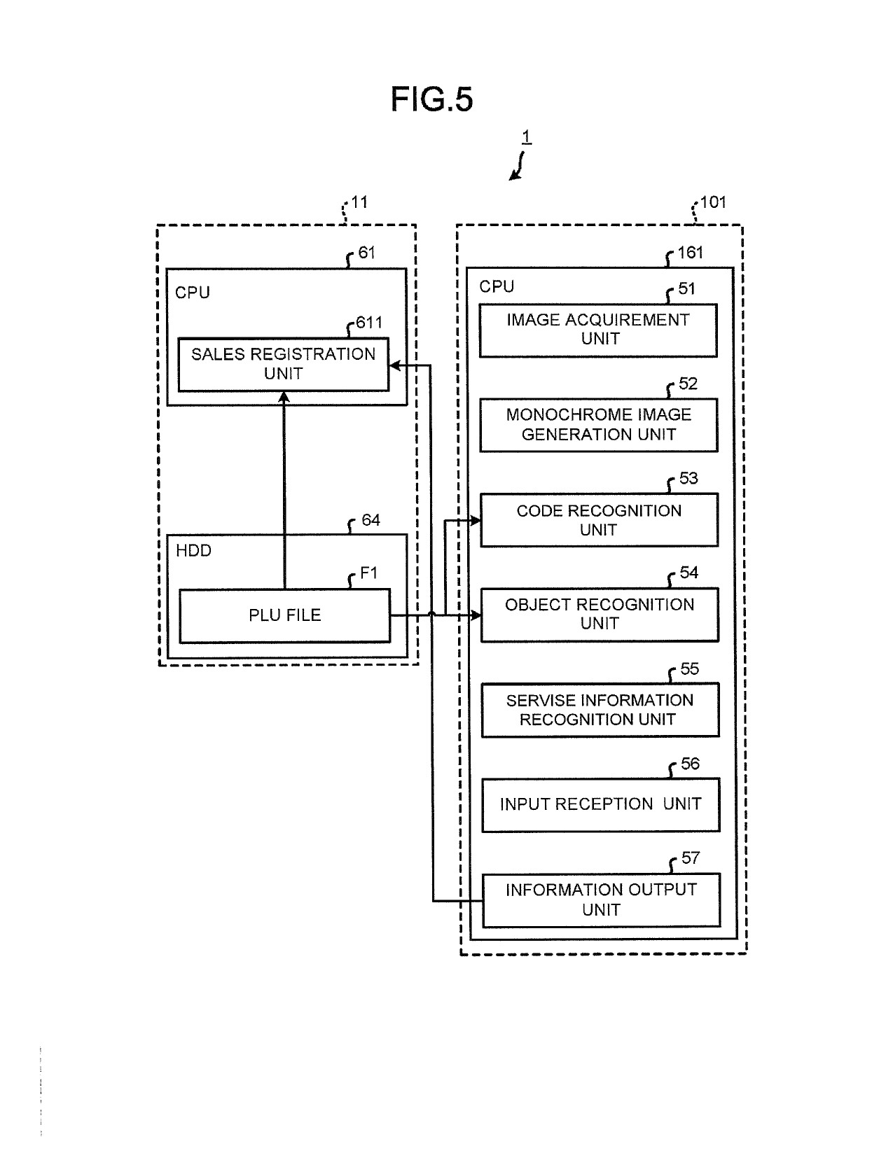

Functional components about the CPU 161 and the CPU 61 realized by executing the program by the CPU 161 and the CPU 61 are described with reference to FIG. 5.

FIG. 5 is a block diagram showing the functional components of the POS terminal 11 and the commodity reading apparatus 101. As shown in FIG. 5, the CPU 161 of the commodity reading apparatus 101 comprises functions as an image acquirement unit 51, a monochrome image generation unit 52, a code recognition unit 53,=an object recognition unit 54, a service information recognition unit 55, an input reception unit 56 and an information output unit 57 by executing the program stored by the ROM 162. In addition, similarly, the CPU 61 of the POS terminal 11 comprises a function as a sales registration unit 611 by executing the program PR.

The image acquirement unit 51 outputs a capturing-on signal to the image capturing unit 164, so that the image capturing unit 164 starts an image capturing operation. The image acquirement unit 51 acquires color frame images captured by the image capturing unit 164 and stored in the RAM 163 after the image capturing operation starts in sequence. The acquirement of the frame images, which is executed by the image acquirement unit 51, is carried out according to a sequence stored in the RAM 163.

The monochrome image generation unit 52 generates a monochrome frame image (the monochrome image) from the color frame image acquired by the image acquirement unit 51. Particularly, based on the acquired color frame image, for instance, a 24-bit full color image is subjected to grayscale conversion towards a 256 gradation monochrome image, so as to carry out the generation of the monochrome image. The monochrome image generation unit 52 generates the monochrome image which is subjected to binarization with a specified threshold value from the monochrome image subjected to the 256 gradation grayscale conversion. The monochrome image generated by the monochrome image generation unit 52 is stored in the RAM 163 in sequence.

The code recognition unit 53 reads the code information of the bar code or a two-dimension code (such as the QR code (registered trademark)) and the like attached to the commodity G captured in the image capturing region B3 based on the monochrome image generated by carrying out the conversion on the color frame image capturing the image capturing region B3. Based on the read code information, the captured commodity G is specified with reference to the PLU file F1. Particularly, the code recognition unit 53 reads out the monochrome image stored in the RAM 163 to carry out the detection of the bar code based on a pattern matching technology and to carry out the detection of the two-dimension code based on a specified finder pattern. The code recognition unit 53 reads the commodity information of the commodity G, such as a commodity code (the commodity ID) and the like from the detected bar code or the two-dimension code. Subsequently, the code recognition unit 53 specifies the commodity G corresponding to the read commodity information (such as commodity code) with reference to the PLU file F1.

The object recognition unit 54 reads the surface state such as the color saturation or the surface concave-convex status and the like of the commodity G captured in the image capturing region B3 as the characteristic quantity based on the color frame image capturing the image capturing region B3. Based on the read characteristic quantity, the captured commodity G is specified with reference to the PLU file F1. Particularly, the object recognition unit 54 reads out the color frame image stored in the RAM 163 to detect the commodities G wholly or partially by utilizing the pattern matching technology and the like. For instance, a contour line and the like are extracted from the image obtained after carrying out the binaryzation on the acquired frame image. The contour line extracted from a last frame image is compared with the contour line extracted from a current frame image, so as to detect the commodity G which is enabled to face to the reading window 103 for carrying out the sales registration.

As other method detecting the commodity, the existence of a skin color region is detected from the acquired frame image. if the skin color region is detected, that is, if the hand of the salesclerk is detected, the extraction of the contour of the commodity supposed to be grabbed by the hand of the salesclerk is tried by carrying out the detection of the above-mentioned contour line near the skin color region. At the moment, if the contour the shape of the hand and the contour of other object near the contour of the hand are detected, the commodity is detected according to the contour of the object.

The object recognition unit 54 in the present embodiment reads the surface state such as the color saturation or the surface concave-convex status and the like of the commodity G from all or part of the images of the commodity G captured by the captured unit 164 as the characteristic quantity. In addition, in order to shorten processing time, the object recognition unit 54 does not consider the contour or the size of the commodity G. However, in the condition of not considering to shorten the processing time, the contour or the size of the commodity G is considered.

The object recognition unit 54 reads the surface state such as the color saturation or the surface concave-convex status and the like of a registered commodity from the commodity image of each commodity (hereinafter, called as registered commodity) registered in the PLU file F1 as the characteristic quantity, and compares the characteristic quantity with the characteristic quantity of the commodity G respectively, so as to calculate a similarity of the commodity G and the commodity registered in the PLU file F1. Herein, the similarity represents a degree with which all or part of the images of the commodity G are similar in the condition that the image of each commodity stored in the PLU file F1 is set to be 100%=“similarity: 1.0”. In addition, for instance, for the hue and the surface concave-convex status, the similarity is calculated by changing a weight. The object recognition unit 54 specifies the commodity whose calculated similarity is highest in the commodities of the PLU file F1 as the captured commodity G.

The object recognition carrying out recognition on the object included in the image in this way is called as generic object recognition. About such generic object recognition, various recognition technologies are described in the following literature.

Yanai Keiji, “present state and perspectives of generic object recognition”, collected papers of information processing society, Vol.48, No.SIG16 [retrieved on August 10, Heisei 22 (2010)], website <URL: http://mm.cs.uec.ac.jp/IPSJ-TCVIM-Yanai.pdf>.

A technology carrying out the generic object recognition by carrying out region segmentation on the image aiming at each target is described in the following literature.

Jamie Shotton and the like, “Semantic Texton Forests for Image Categorization and Segmentation”, [retrieved on August 10, Heisei 22 (2010)], website <URL: http://citeseerx.ist.psu.edu/viewdoc/download?doi=10.1.1.14 5.3036&rep=repl&type=pdf>.

A method calculating the similarity of the image of the captured commodity G and the image of the registered commodity registered in the PLU file F1 is not limited particularly. For instance, the similarity of the image of the captured commodity G and each registered commodity registered in the PLU file F1 can be calculated as absolute evaluation and is calculated as relative evaluation.

If the similarity is calculated as the absolute evaluation, the image of the captured commodity G is compared with each registered commodity registered in the PLU file F1 one to one, and the similarity educed by the result of the comparison is directly adopted. If the similarity is calculated as the relative evaluation, if five registered commodities (commodities GA, GB, GC, GD and GE) are registered in the PLU file F1, the calculation is carried out in the way of enabling the similarity of the captured commodity G and the commodity GA to be 0.6, the similarity of the captured commodity G and the commodity GB to be 0.1, the similarity of the captured commodity G and the commodity GC to be 0.1, the similarity of the captured commodity G and the commodity GD to be 0.1, the similarity of the captured commodity G and the commodity GE to be 0.1, and the like, and the sum of the similarity of the captured commodity G to each registered commodity to be 1.0 (100%).

The service information recognition unit 55 reads a mark image (such as a pattern in a specified shape, which represents a discount seal) in the specified shape, which is printed on a symbol of the discount seal and the like attached to the commodity G according to the monochrome image converted based on the color frame image capturing the image capturing region B3 or the color frame image capturing the image capturing region. B3, so as to specify the symbol such as the discount seal and the like attached to the commodity G. Therefore, the service information recognition unit 55 reads service information such as a discount amount or a discount rate and the like corresponding to the specified discount seal. The information including the service information such as the shape of the symbol such as each discount seal and the like, the image and the characteristic quantity of the symbol and the discount amount or the discount rate and the like corresponding to the discount seal is previously stored in the ROM 162. The service information recognition unit 55 reads out the information relevant with the symbol stored in the ROM 162 and specifies the symbol attached to the commodity G with reference to the monochrome image converted based on the color frame image capturing the image capturing region B3 or the color frame image capturing the image capturing region B3 by the pattern matching technology.

The input reception unit 56 receives various input operations corresponding to the display of the display 106 by utilizing the touch panel 105 or the keyboard 107. For instance, the information output unit 57 enables the confirmation picture of the commodity G specified by the code recognition unit 53 or the object recognition unit 54 to be displayed on the display 106 and receives the input operation (a confirmation operation) carrying out the sales registration of the specified commodity G based on a selection operation aiming at the confirmation picture by utilizing the keyboard 107. The confirmation operation received by the information output unit 57 is notified to the POS terminal 11 by the information output unit 57. After the confirmation operation of the sales registration of the commodity G is carried out, the input reception unit 56 enables an operation picture receiving the number input of the commodity G to be subjected to the sales registration to be displayed on the display 106 and receives the input operation of the number by utilizing the keyboard 107. The number received by the input reception unit 56 is notified to the POS terminal 11 by the information output unit 57. In the POS terminal 11, the notification of the confirmation operation and the number is received, so as to carry out the sales registration in the sales registration unit 611.

The information output unit 57 outputs the information (such as the commodity ID or the commodity name and the like) showing commodity or the number to the POS terminal 11 through the connection interface 175 for the above-mentioned commodity G subjected to the confirmation operation. As the information output to the POS terminal 11 by the information output unit 57, the commodity ID read out from the PLU file F1 by the information output unit 57 can be directly notified based on the commodity G specified by the code recognition unit 53 or the object recognition unit 54, a file name capable of specifying the commodity name or the commodity image of the commodity ID is notified, and the storage location (a storage address in the PLU file F1) of the commodity ID is notified to the POS terminal 11. The information output unit 57 outputs the service information such as the discount amount or the discount rate and the like read out by the service information recognition unit 55 to the POS terminal 11.

The sales registration unit 611 of the POS terminal 11 carries out the sales registration of the corresponding commodity based on the commodity ID output from the information output unit 57, the number subjected to the sales registration, and the service information such as the discount amount or the discount rate and the like. Particularly, the sales registration unit 611 records the notified commodity ID, the commodity category, the commodity name, the unit price and the like corresponding to the commodity ID, the number, the discount amount or the discount rate together in the sales master file and the like with reference to the PLU file F1, so as to carry out the sales registration.

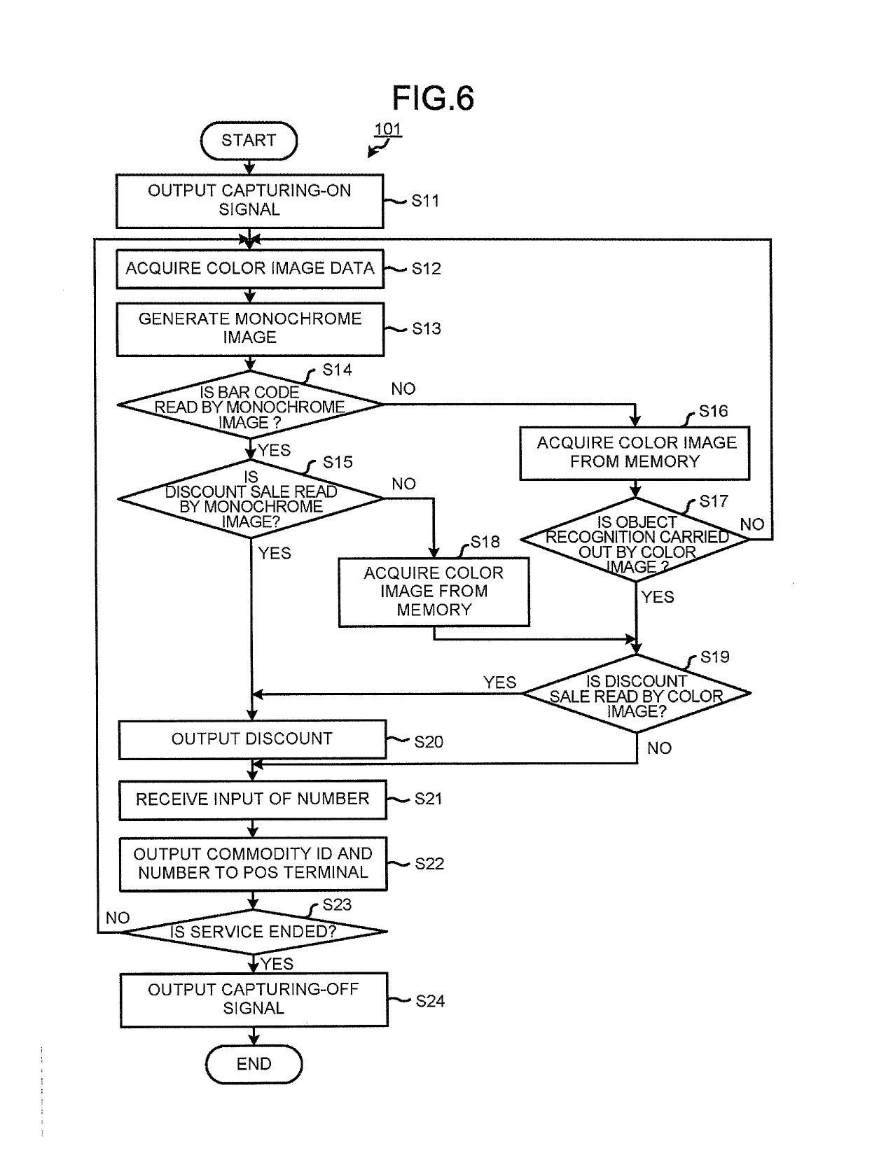

The operations of the checkout system 1 are described in detail. First, the operations of the commodity reading apparatus 101 are described. FIG. 6 is a flow chart showing an example of the operations of the commodity reading apparatus 101.

As shown in FIG. 6, if the processing is started in response to the start and the like of the commodity registration executed by the POS terminal 11, the image acquirement unit 51 outputs a capturing-on signal to the image capturing unit 164 to start the capturing executed by the image capturing unit 164 (S11). The image acquirement unit 51 acquires the color frame image (color image data) captured by the image capturing unit 164 and stored in the RAM 163 (S12). The monochrome image generation unit 52 generates the monochrome image from the color frame image (S13).

The code recognition unit 53 reads the code information of the bar code and the like attached to the commodity G captured in the image capturing region B3 based on the monochrome image generated in S13. The code recognition unit 53 determines whether or not the reading of the code information of the bar code and the like is realized by using the monochrome image generated in S13, that is, determines whether or not the specification of the commodity G is realized by the reading of the code information (S14).

If the reading of the bar code is realized by using the monochrome image (S14: YES), the service information recognition unit 55 carries out the reading of the symbol of the discount seal and the like based on the monochrome image generated in S13. Herein, whether or not the service information recognition unit 55 realizes the reading of the symbol of the discount seal and the like by using the monochrome image generated in S13 is determined, that is, whether or not the reading of the service information such as the discount rate or the discount amount and the like corresponding to the symbol is realized is determined (S15).

If the reading of the discount seal is realized by using the monochrome image (S15: YES), the information output unit 57 outputs the service information such as the discount amount or the discount rate and the like corresponding to the discount seal to the POS terminal 11 (S20).

If the reading of the bar code is not realized by using the monochrome image (S14: NO), the object recognition unit 54 acquires the color frame image stored in a memory such as the RAM 163 and the like (S16), and carries out the specification of the commodity G based on the above-mentioned object recognition based on the acquired color frame image. The object recognition unit 54 determines whether or not the object is recognized by using the color frame image, that is, determines whether or not the specification of the commodity G is realized based on the object recognition (S17). For such determine, if the similarity calculated with reference to the above-mentioned PLU file F1 and aiming at each commodity is less than the specified threshold value, the specification of the commodity G based on the object recognition is determined not to be carried out.

If the object is not recognized by using the color frame image (S17: no), as the frame image acquired in S12 does not realize the specification of the commodity G by any one of the monochrome image and the color image, the processing in S12 is returned to carry out the processing aiming at a next frame image.

If the object recognition is realized by using the color frame image (S17: YES), the service information recognition unit 55 carries out the reading of the symbol of the discount seal and the like based on the color frame image acquired in S16. If the reading of the discount seal is realized by using the monochrome image (S15: no), the service information recognition unit 55 also acquires the color frame image stored in the memory such as the RAM 163 and the like (S18), and carries out the reading of the symbol of the discount seal and the like based on the acquired color frame image. Herein, whether or not the service information recognition unit 55 realizes the reading of the symbol of the discount seal and the like by using the color frame image is determined, that is, whether or not the reading of the service information such as the discount rate or the discount amount and the like corresponding to the symbol is realized is determined (S19).

If the reading of the discount seal is realized by using the color frame image (S19: YES), the information output unit 57 outputs the service information such as the discount amount or the discount rate and the like corresponding to the discount seal to the POS terminal 11 (S20). If the reading of the discount seal is not realized by using the color frame image (S19: NO), as the specification of the commodity G is realized by the frame image acquired in S12 but the reading of the discount seal is not realized, the processing is turned to S21 if the processing in S20 is not carried out.

After S20, the input reception unit 56 receives the input of the number of the commodity G subjected to the sales registration (S21). The information output unit 57 outputs the commodity ID about the commodity G or the number received in S21 to the POS terminal 11 (S22).

The CPU 161 judges the existence of service termination such as termination notification and the like based on the commodity registration from the POS terminal (S23). In the condition of carrying out a service continuously (S23: NO), the CPU 161 returns the processing to S12 to continuously carry out the processing. If the service is terminated (Act S23: YES), the image acquirement unit 51 outputs a capturing-off signal to the image capturing unit 164 to terminate the capturing executed by the image capturing unit 164 (S24), so as to terminate the processing.

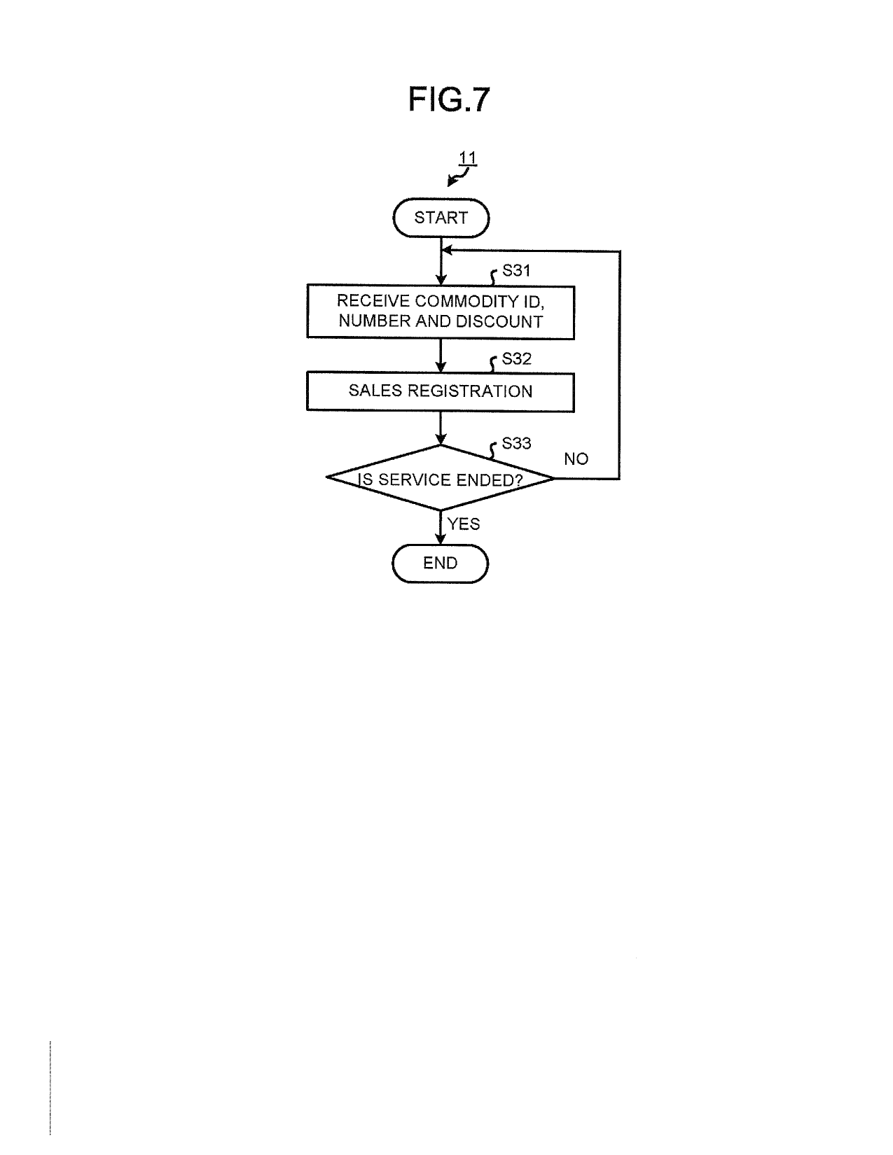

The operations of the POS terminal 11 are described. FIG. 7 is a flow chart showing the acts of the sales registration processing executed by the POS terminal 11.

First, if the processing is started in response to the start and the like of the commodity registration generated by the operation indication of the keyboard 22, the CPU 61 receives the service information relevant with discount, which is output by the commodity reading apparatus 101 in S20 in FIG. 6, and the commodity ID and the number of the commodity G, which are output in S22 (S31). The sales registration unit 611 reads out the commodity category or the unit price and the like from the PLU file F1 based on the commodity ID, the number and the service information which are received in S31 and registers the sale of the commodity G read by the commodity reading apparatus 101 in the sales master file (S32). The CPU 61 determines the existence of the service termination such as the termination and the like of the sales registration generated based on the operation indication of the keyboard 22 (S33). In the condition of carrying out the service continuously (S33: no), the CPU 61 returns the processing to S31 again to continuously carry out the processing. If the service is terminated (S33: YES), the CPU 61 terminates the processing.

As described above, in the commodity reading apparatus 101, the color frame image captured by the image capturing unit 164 is acquired by the image acquirement unit 51, and the acquired color frame image is converted into the monochrome image by the monochrome image generation unit 52, so that the monochrome image is generated from the image captured by the image capturing unit 164. In the code recognition unit 53, the code information attached to the commodity G included in the image captured by the image capturing unit 164 is read based on the monochrome image obtained by the conversion of the monochrome image generation unit 52, so as to specify the commodity G. In the object recognition unit 54, if the specification of the commodity G is not realized by the code recognition unit 53, the object recognition is carried out based on the color frame image acquired by the image capturing unit 164, so as to specify the commodity G included in the frame image. Therefore, in the commodity reading apparatus 101, two image sensors, that is, the image sensor carrying out the capturing on the monochrome image to read the code information and the image sensor carrying out the capturing on the color image to carry out the object recognition (generic object recognition), are not necessary to be provided, so that the simpleness and the convenience of the apparatus can be realized.

In addition, for the symbol corresponding to the service information such as the discount rate or the discount amount and the like of the commodity G, the commodity reading apparatus 101 also reads the mark image (the pattern and the like of the symbol) included in the image captured by the image capturing unit 164 in the code recognition unit 53 based on the monochrome image obtained by the conversion of the monochrome image generation unit 52, so as to carry out the specification of the symbol. If the specification of the commodity G is not realized by the code recognition unit 53, the mark image (the color, the pattern and the like of the symbol) included in the image captured by the image capturing unit 164 in the object recognition unit 54 is read based on the color frame image acquired by the image capturing unit 164, so as to carry out the specification of the symbol. Therefore, in the commodity reading apparatus 101, two image sensors, that is, the image sensor carrying out the capturing on the monochrome image to read the shape of the symbol and the image sensor carrying out the capturing on the color image to read the color of the symbol, are not necessary to be provided, so that the simpleness and the convenience of the apparatus can be realized. If the specification of the symbol is not realized by using the monochrome image, the processing of specifying the symbol by using the color image is carried out again, so that the improvement of the recognition rate of the symbol can be realized. The example that the commodity reading apparatus 101 and the POS terminal 11 are separate compositions is shown in the embodiment, but the commodity reading apparatus 101 and the POS terminal 11 is an integrated composition. In the present embodiment, the checkout system carrying out the sales registration of the commodity G by the salesclerk is exemplified, but a self-service checkout system comprising a scale apparatus is available, and a composition carrying out the sales registration of the commodity G by the customer is available which are needless to say.

The program executed by the commodity reading apparatus 101 of the present embodiment is provided by being previously installed in the ROM and the like. The program executed in the commodity reading apparatus 101 of the present embodiment is formed to be provided by being stored in a computer-readable recording medium such as a CD-ROM, a floppy drive (FD), a CD-R, a DVD (Digital Versatile Disk) and the like with a file in an installable or executable way.

Furthermore, the programs executed by the commodity reading apparatus 101 in the present embodiment is formed to be stored in a computer connected with a network such as the Internet and provided by downloading through a network route. The program executed by the commodity reading apparatus 101 of the present embodiment is formed to be provided or distributed through the network route such as the internet and the like.

The program executed by the commodity reading apparatus 101 of the present embodiment is the composition of a module comprising the above-mentioned units (the image acquirement unit 51, the monochrome image generation unit 52, the code recognition unit 53, the object recognition unit 54, the service information recognition unit 55, the input reception unit 56 and the information output unit 57) and is used as practical hardware. The above-mentioned units are downloaded in a master storage apparatus and generated on the master storage apparatus by reading out the program from the ROM by the CPU (processor) and executing the program.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an image capturing unit;
an acquirement unit configured to acquire a color image captured by the image capturing unit;
an image conversion unit configured to convert the acquired color image into a monochrome image;
a first recognition unit configured to recognize an commodity included in the image captured by the image capturing unit based on the monochrome image;
a second recognition unit configured to recognize the commodity included in the image captured by the image capturing unit based on the acquired color image if the commodity cannot be recognized by the first recognition unit; and
an output unit configured to output information showing the commodity recognized by the first recognition unit or the second recognition unit.

2. The information processing apparatus according to claim 1, wherein
the first recognition unit recognizes the commodity corresponding to a code information by reading the code information included in the monochrome image; and
the second recognition unit recognizes the commodity included in the image captured by the image capturing unit, by reading the characteristic quantity of the commodity included in the red color image and comparing the characteristic quantity with a previously stored characteristic quantity of each commodity, if the commodity corresponding to the code information cannot be recognized.

3. The information processing apparatus according to claim 1, wherein
the first recognition unit recognizes a service information corresponding to a mark image from the mark image showing the service information included in the monochrome image; and
the second recognition unit recognizes the service information corresponding to the mark image from the acquired color image if the service information corresponding to the mark image cannot be recognized.

4. The information processing apparatus according to claim 2, wherein
the first recognition unit recognizes service information corresponding to a mark image from the mark image showing the service information included in the monochrome image ; and
the second recognition unit recognizes the service information corresponding to the mark image from the acquired color image if the service information corresponding to the mark image cannot be recognized.

5. A method, comprising:
acquiring a color image captured by an image capturing unit;
converting the acquired color image into a monochrome image;
recognizing an commodity included in the image captured by the image capturing unit based on the monochrome image;
recognizing the commodity included in the image captured by the image capturing unit based on the acquired color image if the commodity cannot be specified based on the monochrome image; and
outputting information showing the commodity recognized.

6. The method according to claim 5, wherein
recognizing the commodity corresponding to a code information by reading the code information included in the monochrome image; and
recognizing the commodity included in the image captured by the image capturing unit, by reading the characteristic quantity of the commodity included in the red color image and comparing the characteristic quantity with a previously stored characteristic quantity of each commodity, if the commodity corresponding to the code information cannot be recognized.

7. The program according to claim 5, wherein
recognizing a service information corresponding to a mark image from the mark image showing the service information included in the monochrome image; and
recognizing the service information corresponding to the mark image from the acquired color image if the service information corresponding to the mark image cannot be recognized.

8. The program according to claim 6, wherein
recognizing a service information corresponding to a mark image from the mark image showing the service information included in the monochrome image; and
recognizing the service information corresponding to the mark image from the acquired color image if the service information corresponding to the mark image cannot be recognized.

9. An information processing apparatus, comprising:
a scanner configured to capture an color image of a commodity;
a memory configured to storage the color image;
an image conversion unit configured to convert the color image into a monochrome image;
a first recognition unit configured to recognize an commodity based on the monochrome image;
a second recognition unit configured to recognize an commodity based on the color image at the memory if an commodity cannot be recognized by the first recognize unit; and
an output unit configured to output information showing an commodity determined by the first recognize unit or the second recognize unit.

10. The information processing apparatus according to claim 9, wherein
the first recognize unit recognizes an commodity corresponding to a code information by the code information included in the monochrome image; and
the second recognize unit recognizes an commodity based on stored the color image at the memory, by comparing the characteristic quantity of an commodity included in the color image with a previously stored characteristic quantity of each commodity, if the commodity corresponding to the code information cannot be recognized.

11. The information processing apparatus according to claim 9, wherein
the first recognize unit recognizes a service information corresponding to a mark image from the mark image showing the service information included in the monochrome image; and
the second recognize unit recognizes the service information corresponding to the mark image from the acquired color image if the service information corresponding to the mark image cannot be recognized.

12. The information processing apparatus according to claim 10, wherein
the first recognize unit recognizes a service information corresponding to a mark image from the mark image showing the service information included in the monochrome image; and
the second recognize unit recognizes the service information corresponding to the mark image from the acquired color image if the service information corresponding to the mark image cannot be recognized.

13. A method, comprising:
capturing an color image of a commodity;
storing the color image captured;
converting the color image into a monochrome image;
recognizing an commodity based on the monochrome image;
recognizing an commodity based on the color image if an commodity cannot be recognized by the first recognize unit; and
outputting information showing an commodity determined.

14. The method according to claim 13, wherein
recognizing an commodity corresponding to a code information by the code information included in the monochrome image; and
recognizing an commodity based on stored the color image, by comparing the characteristic quantity of an commodity included in the color image with a previously stored characteristic quantity of each commodity, if the commodity corresponding to the code information cannot be recognized.

15. The method according to claim 13, wherein
recognizing a service information corresponding to a mark image from the mark image showing the service information included in the monochrome image; and
recognizing the service information corresponding to the mark image from the acquired color image if the service information corresponding to the mark image cannot be recognized.

16. The method according to claim 14, wherein
recognizing a service information corresponding to a mark image from the mark image showing the service information included in the monochrome image; and
recognizing the service information corresponding to the mark image from the acquired color image if the service information corresponding to the mark image cannot be recognized.
